(19) United States
(12) Patent Application Publication
(10) Pub. No.: US 2017/0021762 A1
(43) Pub. Date: Jan. 26, 2017

(54) Haptic System And Method Of Controlling A Haptic System

(71) Applicants: DENSO International America, Inc., Southfield, MI (US); DENSO CORPORATION, Kariya-shi (JP)

(72) Inventor: Laith DAMAN, Novi, MI (US)

(21) Appl. No.: 14/806,176

(22) Filed: Jul. 22, 2015

(51) Int. Cl. B60Q 9/00

(52) U.S. Cl. CPC B60Q 9/00

(57) ABSTRACT

The present teachings provide for a vehicle system including a haptic device, a sensor, and a controller and a method for controlling a haptic device. The haptic device can be configured to provide haptic feedback to an occupant of a vehicle. The sensor can be configured to detect vibrations felt by the occupant within the vehicle. The controller can be configured to control a level of the haptic feedback. The controller can be configured to increase or decrease the level of the haptic feedback based on vibrations detected by the sensor.

### FIELD

The present disclosure relates to a haptic system and a method for controlling a haptic system.

### BACKGROUND

This section provides background information related to the present disclosure which is not necessarily prior art.

Haptic technology simulates the sense of touch to communicate with and provide feedback to users. Automobiles currently use haptic technology in touchpads or touch screens and joysticks to assist users in making menu selections in a dashboard display. For example, as the user moves the joystick, a tactile sensation such as a “bump” or, more precisely, a “detent” is felt by the user when a possible selection is encountered. Haptic devices can also be used throughout a vehicle to generate tactile sensations through different body parts depending on where the devices are located. For example, a haptic steering wheel can emit tactile feedback that will be felt through the driver's hand. A haptic seat can alert a driver by sending tactile feedback to the driver's upper or lower body.

A wide range of technology can generate haptic feelings. For example, haptic feelings can be generated by piezoelectric materials, DC motors with eccentric rotating mass (“ERM”) vibration motors, AC motors with linear resonant actuators (“LRA” s), and Electro-Active Polymer (EAP) actuators. Linear and rotary actuators can be used to shake the surface or the entire device to provide haptic feedback to the user. Piezo actuation flexes the surface with piezo disks or strips. Surfaces of the device can be physically moved with electrostatic or electromagnetic attraction. Electro-active polymers can move the surface by contraction and expansion. Capacitive Electrosensory Interfaces (“CEI”) can generate electrostatic pressure and stimulation in finger nerve-endings of the user through the application of an electric field.

The ability of the driver to “communicate” with the vehicle through the sense of touch can greatly reduce the driver's need to view elements other than the road. Intensity of the feeling communicated to the driver is typically a preset or user defined level of intensity that is set when the vehicle is not moving. Unfortunately, when a vehicle is operating or is in motion, it is subject to external noise and vibration. For example, a vehicle driving over gravel will vibrate more than one riding on a flat road. In such scenarios, the tactile sensation felt by the user of the haptic device can be diluted, reducing the effectiveness of the haptic features.

### SUMMARY

This section provides a general summary of the disclosure, and is not a comprehensive disclosure of its full scope or all of its features. The present teachings provide for a vehicle system and a method of controlling a vehicle's haptic interface. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an example of a vehicle having a haptic system in accordance with the present teachings;

FIG. 2 is an example of a display for use with the haptic system of FIG. 1;

FIG. 3 is a portion of a haptic system for use in the vehicle of FIG. 1, illustrating a haptic force generator;

FIG. 4 is an example of a haptic force generator;

FIG. 5 is a flow chart illustrating a method of controlling a haptic sensation setting of a haptic system;

FIG. 6 is a flow chart illustrating a method of adjusting a haptic sensation setting of a haptic system; and

FIG. 7 is a flow chart illustrating another method of adjusting a haptic sensation of a haptic system.

Corresponding reference numerals indicate corresponding parts throughout the several views of the drawings.

### DETAILED DESCRIPTION

Example embodiments will now be described more fully with reference to the accompanying drawings.

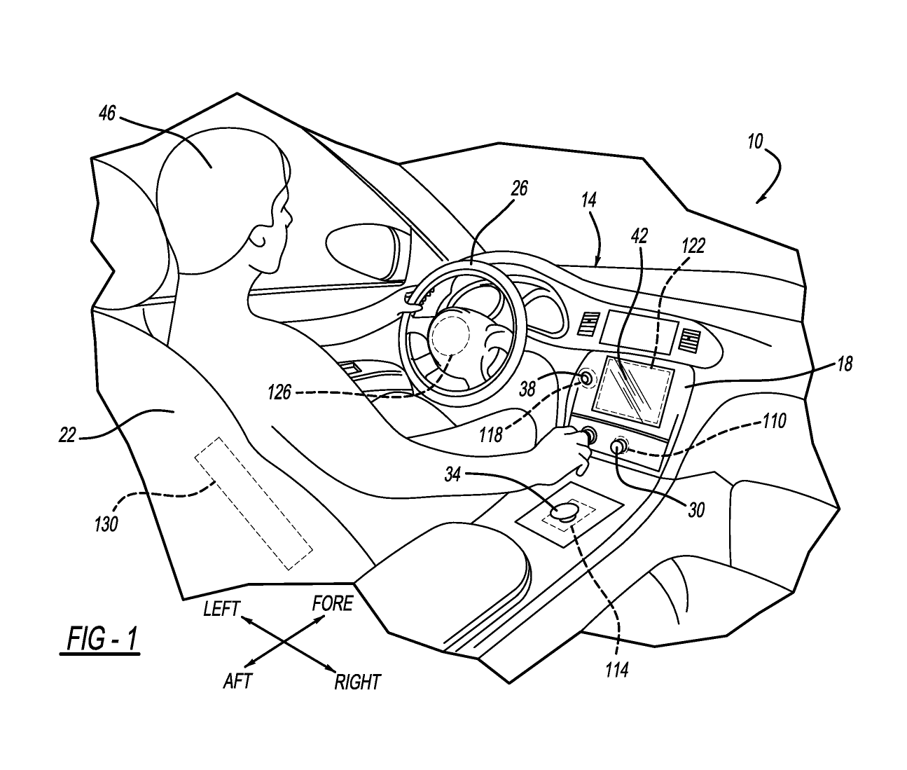

With reference to FIG. 1, an example of an interior of a vehicle 10 including a haptic system 14 is illustrated. The vehicle 10 can include a dashboard or instrument panel 18, one or more seats 22, a steering member (e.g. a steering wheel 26) and one or more selector devices (e.g. first, second, and third selector devices 30, 34, 38).

The instrument panel 18 can include a display 42. The selector devices 30, 34, 38 can be configured to permit a user (e.g. an occupant of the vehicle 10) 46 to control one or more aspects of the vehicle 10 by physically touching the selector device 30, 34, 38. In the example provided, the instrument panel 18 includes the first selector device 30 and the second selector device 34, and the steering wheel includes the third selector device 38, though other configurations can be used. The selector devices 30, 34, 38 can be used to control any suitable type of vehicle system, such as controlling information shown on the display 42, climate control (e.g. heating or cooling), entertainment (e.g. radio or video settings or volume levels), communication (e.g. cellular, email, or internet), or navigation for example.

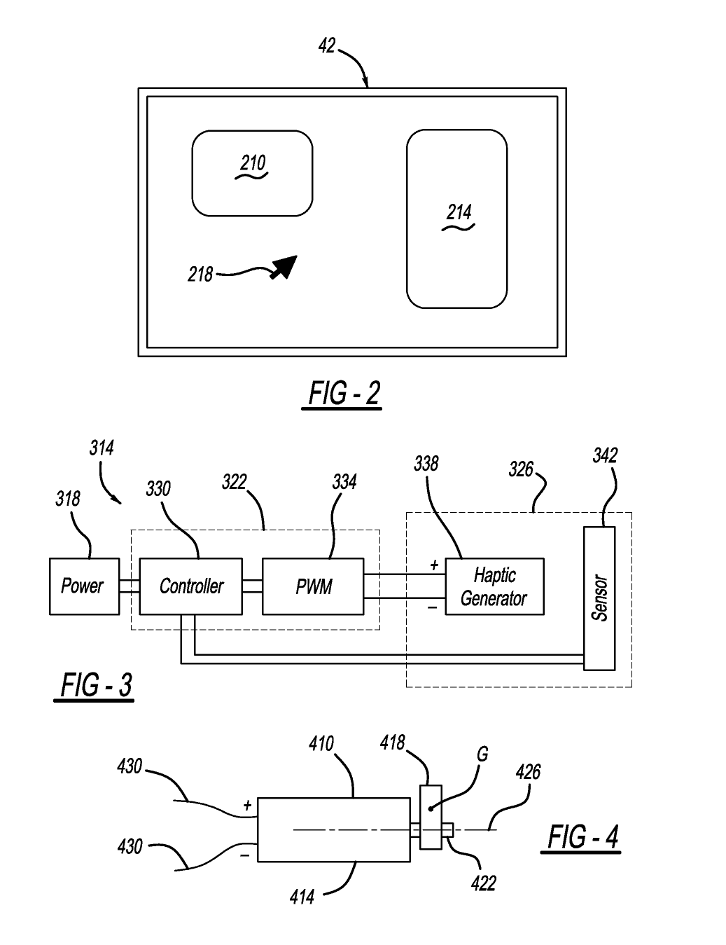

With reference to FIGS. 1 and 2, the display 42 can be configured to display information in any suitable manner or format. For example, the display 42 can display a first set of information 210 and a second set of information 214 different or apart from the first set of information 210. It is appreciated that additional sets of information can be displayed. In the example provided, the display 42 can also display a pointer 218. The first and second sets of information 210, 214 can be in any suitable form, such as images, video, animation, text, or icons for example. The first and second sets of information 210, 214 can be representative of a state or condition of a vehicle system such as climate control (e.g. heating or cooling), entertainment (e.g. radio or video settings or volume levels), communication (e.g. cellular, email, or internet), or navigation for example. The user 46 can use the selector devices 30, 34, 38 to select the first or second sets of information 210, 214. For example, the user 46 can use one of the selector devices 30, 34, 38 to move the pointer 218 over the first or second set of information 210, 214 and operate the selector device 30, 34, 38 to select that set of information 210, 214. Selecting one of the sets of information 210, 214 can cause the display 42 to display additional or alternative information, can change the way the sets of information 210, 214 are displayed, or can adjust aspects of a vehicle system.

The selector devices 30, 34, 38 can be any suitable type of device, such as a knob, joystick, button, switch, slider, track pad, mouse, wheel, track ball, or suitable combination thereof for example. In the example provided, the first selector device 30 can be a knob that can be rotated relative to the instrument panel 18. The first selector device 30 can also be coupled to the instrument panel 18 such that the first selector device 30 can be pressed inward like a button.

In the example provided, the second selector device 34 can be a joystick that can be moved or translated a limited distance in any direction (e.g. fore-aft, left-right, or diagonally therebetween). Alternatively or additionally, the second selector device 34 can pivot and/or rotate in any direction. In the example provided, the third selector device 38 is one or more buttons located on the instrument panel 18. It is appreciated that additional selector devices can be located elsewhere such as the seat 22, steering wheel 26, a door, a center console, or a headliner for example.

In the example provided, the display 42 is a touch sensitive display, such that the user 46 can alternatively select between the first and second sets of information 210, 214 by touching the surface of the display 42. For example, the user 46 can physically touch the display 42 where the first set of information 210 is displayed to select the first set of information 210. The display 42 can use any suitable touch-screen technology to determine the region of the display 42 that the user 46 desires to select. In this way, the display 42 itself is also a fourth selector device.

The seats 22 can be configured to support occupants of the vehicle 10 in a conventional manner. In the example provided, one of the seats 22 is configured to support a driver of the vehicle 10, while another of the seats 22 is configured to support a passenger of the vehicle 10. The steering wheel 26 can be configured to control the steering of the vehicle 10 in a conventional manner.

The haptic system 14 can include one or more haptic devices and in the example provided, includes first, second, third, fourth, fifth, and sixth haptic devices 110, 114, 118, 122, 126, 130. The first haptic device 110 can be coupled to the first selector device 30 to provide haptic feedback to the user 46 when the user 46 interacts with the first selector device 30. For example, the first haptic device 110 can actively resist the user's 46 effort to turn the knob that is the first selector device 30 when rotating the first selector device 30 further would not be desirable or beneficial to the user 46 (e.g. when the pointer 218 reaches an edge of the display 42, or when the highest setting of the vehicle system is reached). Alternatively or additionally, the first haptic device 110 can vibrate the first selector device 30 to indicate that the user 46 has selected a certain setting (e.g. when the pointer 218 moves over either of the sets of information 210, 214 on the display 42, or when the next setting of the vehicle system is reached). The first haptic device 110 can use any suitable type of haptic feedback technology, such as piezoelectric materials, motors with an eccentric rotating mass, motors with linear resonant actuators, capacitive electro-sensory interfaces, or electro-active polymer actuators for example.

The second haptic device 114 can be coupled to the second selector device 34 to provide haptic feedback to the user 46 when the user 46 interacts with the second selector device 34. For example, the second haptic device 114 can actively resist the user's 46 effort to move the joystick that is the second selector device 34 when moving the second selector device 34 further would not be desirable or beneficial to the user 46 (e.g. when the pointer 218 reaches an edge of the display 42, or when the highest setting of the vehicle system is reached). Alternatively or additionally, the second haptic device 114 can vibrate the second selector device 34 to indicate that the user 46 has selected a certain setting (e.g. when the pointer 218 moves over either of the sets of information 210, 214 on the display 42, or when the next setting of the vehicle system is reached). The second haptic device 114 can use any suitable type of haptic feedback technology, such as piezoelectric materials, motors with an eccentric rotating mass, motors with linear resonant actuators, capacitive electro-sensory interfaces, or electro-active polymer actuators for example.

The third haptic device 118 can be coupled to the third selector device 38 to provide haptic feedback to the user 46 when the user 46 interacts with the third selector device 38. For example, the third haptic device 118 can actively resist the user's 46 effort to press the button(s) that is/are the third selector device 38 when moving the third selector device 38 further would not be desirable or beneficial to the user 46 (e.g. when the pointer 218 reaches an edge of the display 42, or when the highest setting of the vehicle system is reached). Alternatively or additionally, the third haptic device 118 can vibrate the third selector device 38 to indicate that the user 46 has selected a certain setting (e.g. when the pointer 218 moves over either of the sets of information 210, 214 on the display 42, or when the next setting of the vehicle system is reached). The third haptic device 118 can use any suitable type of haptic feedback technology, such as piezoelectric materials, motors with an eccentric rotating mass, motors with linear resonant actuators, capacitive electro-sensory interfaces, or electro-active polymer actuators for example.

The fourth haptic device 122 can be coupled to or integrally formed with the fourth selector device (i.e. the display 42) to provide haptic feedback to the user 46 when the user 46 interacts with the display 42. For example, the fourth haptic device 122 can actively resist the user's 46 effort to press on the display 42 or move his/her finger on the display 42 when doing so would not be desirable or beneficial to the user 46 (e.g. when the pointer 218 reaches an edge of the display 42, or when the highest setting of the vehicle system is reached). Alternatively or additionally, the fourth haptic device 122 can vibrate the display 42 to indicate that the user 46 has selected a certain setting (e.g. when the pointer 218 moves over either of the sets of information 210, 214 on the display 42, or when the next setting of the vehicle system is reached. The fourth haptic device 122 can use any suitable type of haptic feedback technology, such as piezoelectric materials, motors with an eccentric rotating mass, motors with linear resonant actuators, capacitive electro-sensory interfaces, or electro-active polymer actuators for example.

The fifth haptic device 126 can be coupled to the steering wheel 26 to provide haptic feedback to the user 46 when the user 46 interacts with the steering wheel 26. For example, the fifth haptic device 126 can actively resist the user's 46 effort to turn the steering wheel 26 when rotating the steering wheel 26 further would not be desirable or beneficial to the user 46 (e.g. when turning the steering wheel 26 would otherwise cause the vehicle 10 to hit an obstacle or another vehicle or to leave the lane in which the vehicle is travelling). Alternatively or additionally, the fifth haptic device 126 can vibrate the steering wheel 26 to indicate that turning the steering wheel 26 further may not be beneficial to the user 46. The fifth haptic device 126 can use any suitable type of haptic feedback technology, such as motors, piezoelectric materials, motors with an eccentric rotating mass, motors with linear resonant actuators, capacitive electro-sensory interfaces, or electro-active polymer actuators for example.

The sixth haptic device 130 can be coupled to the seat 22 to provide haptic feedback to the user 46 when the user 46 is supported by the seat 22 and a predetermined event occurs. For example, the sixth haptic device 130 can vibrate the seat 22 or a portion of the seat 22 when the user 46 attempts to turn the steering wheel 26, but rotating the steering wheel 26 would not be desirable or beneficial to the user 46 (e.g. when turning the steering wheel 26 would otherwise cause the vehicle 10 to hit an obstacle or another vehicle or to leave the lane in which the vehicle is travelling). By way of another non-limiting example, the sixth haptic device 130 could alert the user 46 to conditions outside the vehicle 10, such as another vehicle (not shown) in the user's 46 blind spot, or an obstacle in the vehicle's 10 path. The fifth haptic device 126 can use any suitable type of haptic feedback technology, such as piezoelectric materials, motors with an eccentric rotating mass, motors with linear resonant actuators, capacitive electro-sensory interfaces, or electro-active polymer actuators for example.

With additional reference to FIG. 3, a portion of a haptic system 314 is illustrated. The haptic system 314 can be used in a vehicle such as vehicle 10 (FIG. 1) and can be used to provide haptic feedback to any suitable device such as the first, second, or third selector devices 30, 34, 38, the steering wheel 26, the seats 22, or the display 42 (FIG. 1) for example. The haptic system 314 can include a power source 318, a control module 322, and a haptic device 326. The power source 318 can be any suitable electrical power source such as a battery, capacitor, super capacitor, or alternator for example.

The control module 322 can include a controller 330 and can include a pulse width modulator 334 (“PWM”). The controller 330 can be any suitable controller such as a microcontroller for example. The controller 330 can be dedicated to the haptic system 314 or can be configured to also control or interact with other systems of the vehicle 10 (FIG. 1). The controller 330 can be electrically coupled to the power source 318 to receive electrical power therefrom. The controller 330 can be electrically coupled to the PWM 334 and the haptic device 326, and can control power from the power source 318 to the PWM 334 and to the haptic device 326. The controller 330 can also receive signals from the haptic device 326 as discussed below. The PWM 334 can be any suitable pulse width modulating device such as a pulse width modulating integrated circuit for example.

The haptic device 326 can include a haptic force generator 338 and a sensor 342. The haptic force generator 338 can be any suitable device that can provide the user 46 (FIG. 1) of a device (e.g. selector device 30, 34, 38, steering wheel 26, seats 22, or display 42; FIG. 1) with a haptic sensation. FIG. 4 illustrates one, non-limiting example of a haptic force generator 410. In the example shown in FIG. 4, the haptic force generator 410 is an eccentric rotating mass force generator that can include a motor 414 and a mass 418. It is understood that the haptic force generator 410 can be any other suitable type of haptic sensation producing device, such as piezoelectric materials, electric motors with linear resonant actuators (“LRA”s), electric motors coupled to a device (e.g. selector device 30, 34, 38, or steering wheel 26; FIG. 1) to resist rotation of the device, or Electro-Active Polymer (EAP) actuators for example.

In the example provided, the mass 418 is drivingly coupled to an output shaft 422 of the motor 414 and can have a center of gravity G that is offset from a rotational axis 426 of the output shaft 422. The motor 414 can be any suitable motor for rotating the output shaft 422, such as a DC motor for example. The motor 414 can have a set of leads 430 that can be electrically coupled to the PWM 334 (FIG. 3) to receive power from the power source 318 (FIG. 3). When the motor 414 receives electrical power, the motor 414 can rotate the output shaft 422 about the axis 426, which can rotate the mass 418 about the axis 426. Since the center of gravity G of the mass 418 is offset from the axis 426, rotation of the mass 418 about the axis 426 can vibrate the haptic device 326 and can vibrate the selector device 30, 34, 38, steering wheel 26, seats 22, or display 42 (FIG. 1) to provide a haptic sensation to the user 46 (FIG. 1).

In an alternative construction, not specifically shown, the output shaft 422 can be coupled to a rotatable selector device (e.g. steering wheel 26 or selector device 30, 34) such that rotation of the output shaft 422 can provide torque in a rotational direction that is opposite the direction that the user 46 (FIG. 1) intends to turn the selector device 30, 34, or steering wheel 26. In other words, the motor 414 can resist the user's 46 effort to rotate the selector device 30, 34, or steering wheel 26 when the motor receives power.

Returning to FIG. 3, a haptic sensation setting of the controller 330 can correspond to an amount and/or duration of electrical power (e.g. voltage, current, duty cycle, amplitude, frequency, duration) delivered by the control module 322 to the haptic force generator 338. A minimum or baseline haptic sensation level can be programmed into the controller 330 and can be a sensitivity setting such that the user 46 (FIG. 1) can adequately feel the haptic feedback from the haptic force generator 338 when noise (e.g. vibration not caused by the haptic device 326) that is felt by the user 46 is minimal. For example, the baseline haptic sensation level can be calibrated by the user 46 or preset to achieve adequate haptic feeling when substantially all vibration inducing systems of the vehicle 10 (e.g. engine, audio, heating or cooling) are not operating and the vehicle 10 (FIG. 1) is stationary in a calm and quiet location (i.e. external vibrations are minimal). The noise referred to herein can be detected by the sensor 342 as discussed below. It is understood that the noise can be expressed as a waveform having a frequency and an amplitude value. The baseline haptic sensation level can be the default for the haptic sensation setting. The haptic sensation setting or sensitivity can be different from the baseline haptic sensation level when certain conditions are met, as described below.

The sensor 342 can be any suitable type of sensor that can sense vibration. For example, the sensor 342 can be an accelerometer, a piezo-electric sensor, a magnetic sensor, a microphone, or any other type of acoustic or vibration sensor. Alternatively, or additionally, the sensor can detect a condition of the vehicle 10 (FIG. 1), a system of the vehicle 10, or the environment around the vehicle 10 indicative of vibration within the vehicle 10. For example, the sensor 342 can detect the speed of the vehicle 10, the speed (e.g. revolutions per minute) of the vehicle's engine, or a condition of a road surface (e.g. gravel, pavement, dirt). It is understood that the haptic device 326 can include a plurality of sensors 342 (e.g. a first, second, and third sensor) which can be of different types of sensors and can be located in different areas of the vehicle 10.

The sensor 342 can be electrically coupled to the controller 330 to output signals (e.g. indicative of the information sensed by the sensor 342) to the controller 330. The controller 330 can use the signals received from the sensor 342 to control the amplitude, frequency, and/or duration of electrical power provided to the haptic force generator 338, as discussed below. The sensor 342 can be located anywhere within or outside of the vehicle 10 (FIG. 1). When the sensor 342 is a vibration sensor, the sensor 342 can be located within the vehicle 10 near to or within the selector device 30, 34, 38, steering wheel 26, seats 22, or display 42 (FIG. 1) and near to the haptic force generator 338 such that the sensor 342 can measure vibrations at the selector device 30, 34, 38, steering wheel 26, seats 22, or display 42.

The noise can be the vibrations sensed at the selector device 30, 34, 38, steering wheel 26, seats 22, or display 42 (FIG. 1) that are not caused by the haptic device 326. For example, the noise can be vibrations due to the wheels, type of road surface, wind, audio equipment (e.g. radio), other vehicles, and/or the engine. Alternatively or additionally, the noise can be a calibrated or calculated value based on predetermined values or other conditions sensed by the sensor 342. For example, if the sensor 342 senses the speed of the engine, the speed of the vehicle 10 (FIG. 1), the type of road surface, and/or the volume of an audio system, then the noise due to these conditions can be calculated, determined, or estimated by the controller 330 based on predetermined values. As the level of noise increases, it can become difficult for the user 46 (FIG. 1) to differentiate between the noise and the haptic feedback provided at the baseline haptic sensation level.

It is generally understood that, given constant noise conditions, the strength of the haptic feedback sensation felt by the user 46 (FIG. 1) can depend on a number of variables, including the duration of time, the frequency, and the amplitude of electrical power that is supplied to the haptic force generator 338. In one non-limiting example, for a given duration of time that power is supplied to the haptic force generator 338, the haptic sensation felt can generally increase with increased frequency until a maximum sensation level is achieved. By way of another non-limiting example, for a given frequency, the haptic sensation felt can generally increase with increased duration of power supplied to the haptic force generator 338. In yet another non-limiting example, for a given duration of time that power is supplied to the haptic force generator 338, the haptic sensation can increase as amplitude of power increases.

In general, the haptic sensation felt by the user 46 (FIG. 1) can be described by a relationship or function:

f(h_f)={(F_r+F_t+F_e+F_w+V_v+V_o)*K}*C_k

In the above function, h_f is the haptic feedback forces felt by the user 46 (FIG. 1). F_r is the noise from a radio. Ft is the noise from the interaction between the road and tires of the vehicle 10. F_e is the noise from the engine of the vehicle 10. F_w is the noise from wind or other atmospheric conditions about the vehicle 10. V_v is the vehicle's 10 velocity. V_o are other vibrations felt within the vehicle 10. K is a multiplication tune factor that can depend on the specific configuration of the vehicle 10 and can be preset based on calibrated values for the vehicle 10. C_k is a user haptic feedback calibration constant that can be set by the user 46. It is understood that this relationship is a functional relationship and that additional or different terms can be used in the functional relationship.

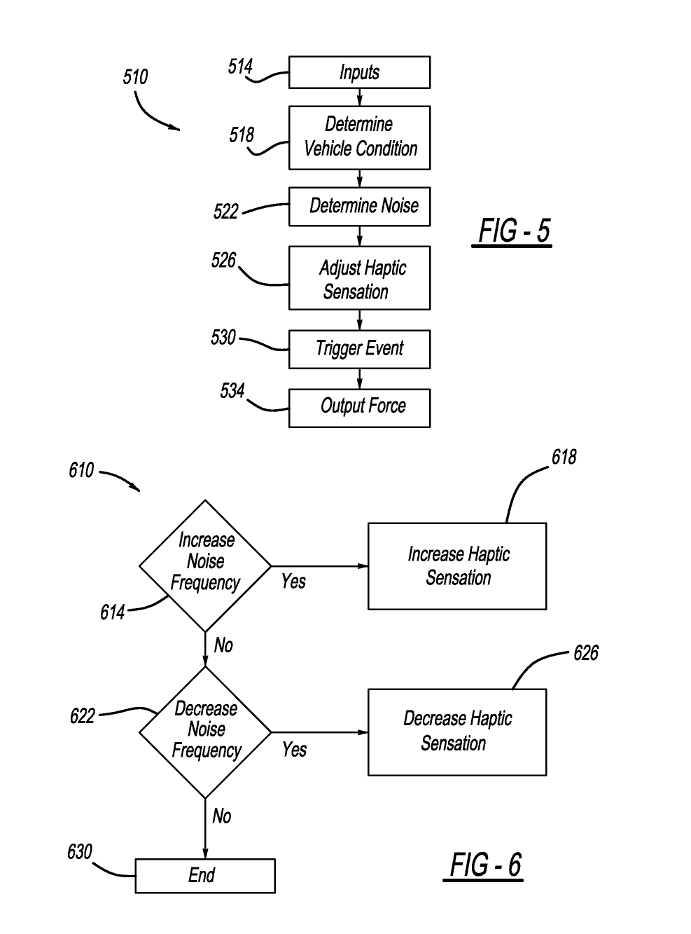

With additional reference to FIG. 5, a first logic routine 510 that can be programmed into the control module 322 (FIG. 3) is illustrated in flow chart form. The first logic routine 510 can be used by the controller 330 (FIG. 3) to adjust the output of the haptic force generator 338 (FIG. 3) to achieve a uniform haptic feedback sensation felt by the user 46 (FIG. 1) when the level of noise changes. At step 514, the controller 330 can receive input signals from the sensors 342 (FIG. 3). After receiving inputs from the sensors 342 the first logic routine 510 can proceed to step 518. In an alternative construction, the first logic routine 510 does not include or can skip step 518 to proceed directly to step 522.

At step 518, the controller 330 (FIG. 3) can determine a vehicle condition such as the speed of the vehicle's 10 (FIG. 1) engine or motor, the speed (i.e. velocity) of the vehicle 10, the type of road surface on which the vehicle 10 is operating, and/or the volume setting of the audio system of the vehicle 10. It is understood that other vehicle conditions can be used. After determining the vehicle condition, the first logic routine 510 can proceed to step 522. In an alternative construction, the first logic routine 510 does not include or can skip step 522 to proceed directly to step 526.

At step 522, the controller 330 (FIG. 3) can determine the level of noise (e.g. vibrations not caused by the haptic force generator 338 as discussed above with reference to FIG. 3) at the selector device 30, 34, 38, steering wheel 26, seats 22, or display 42 (FIG. 1). After determining the level of noise, the first logic routine 510 can proceed to step 526. At step 526, the controller 330 can set or adjust the haptic sensation setting or sensitivity such that the haptic sensation felt by the user 46 (FIG. 1) is substantially the same for any level of noise. The adjustment of the haptic sensation setting is described in greater detail below. After setting or adjusting the haptic sensation setting, the first logic routine 510 can proceed to step 530.

At step 530, the controller 330 (FIG. 3) can detect a triggering event from a sensor (e.g. sensor 342, or selector device 30, 34, 38, steering wheel 26, or display 42). For example, sensor 342 can detect an object in the user's 46 blind spot, or the user can touch one of the selector devices 30, 34, 38, steering wheel 26 or display 42. After detecting the triggering event, the first logic routine 510 can proceed to step 534.

At step 534, the controller 330 (FIG. 3) can control the haptic device 110, 114, 118, 122, 126, 130 to output a haptic feedback force perceptible to the user 46.

With additional reference to FIG. 6, a second logic routine 610 that can be programmed into the control module 322 (FIG. 3) is illustrated in flow chart form. The second logic routine 610 can be used by the controller 330 (FIG. 3) to adjust the output of the haptic force generator 338 (FIG. 3) to achieve a uniform haptic feedback sensation felt by the user 46 (FIG. 1) when the level of noise changes. For example, the second logic routine 610 can be used by the controller 330 in step 526 of the first logic routine 510 to adjust the haptic sensation setting.

At step 614, the controller 330 (FIG. 3) can determine if the noise sensed by the sensors 342 (FIG. 3) has changed frequency. If the noise frequency has increased, then the logic routine 610 can proceed to step 618.

At step 618, the controller 330 (FIG. 3) can change the haptic sensation setting or sensitivity such that the haptic force generator 338 (FIG. 3) will output a haptic sensation generally equal to the haptic sensation that would have been felt before the noise frequency increased. For example, the controller 330 can increase a frequency value of the haptic sensation setting such that the frequency of the power supplied to the haptic force generator 338 can be higher. Alternatively, the controller 330 can adjust the amplitude or the duration of power to the haptic force generator 338 to achieve the uniform haptic sensation.

Returning to step 614, if the noise frequency has not increased, then the logic routine 610 can proceed to step 622. At step 622, the controller 330 (FIG. 3) can determine if the noise sensed by the sensors 342 (FIG. 3) has changed frequency. If the noise frequency has decreased, then the logic routine 610 can proceed to step 626. It is understood that the order of steps 614 and 622 can be reversed such that the controller 330 can determine if the noise frequency has decreased first.

At step 626, the controller 330 (FIG. 3) can change the haptic sensation setting or sensitivity such that the haptic force generator 338 (FIG. 3) will output a haptic sensation generally equal to the haptic sensation that would have been felt before the noise frequency decreased. For example, the controller 330 can decrease the frequency value of the haptic sensation setting such that the power supplied to the haptic force generator 338 has a lower frequency. Alternatively, the controller 330 can adjust the amplitude or the duration of power to the haptic force generator 338 to achieve the uniform haptic sensation.

Returning to step 622, if the noise frequency has not increased, then the logic routine 610 can proceed to step 630. At step 630, the logic routine 610 can end and the controller 330 (FIG. 3) can leave the haptic sensation setting unchanged.

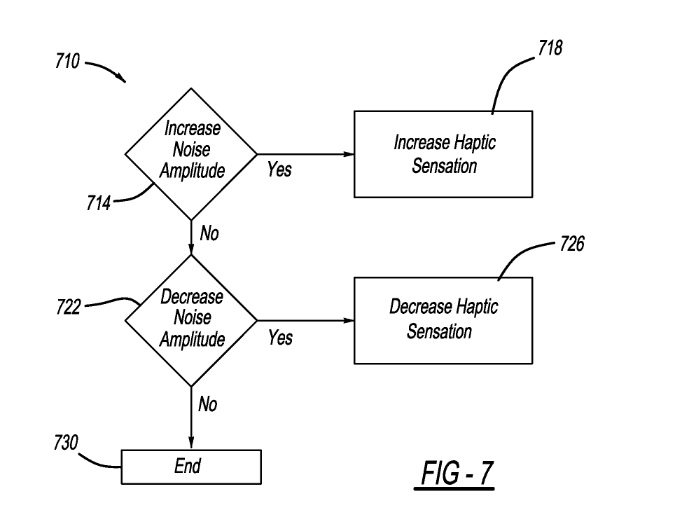

With additional reference to FIG. 7, a third logic routine 710 that can be programmed into the control module 322 (FIG. 3) is illustrated in flow chart form. The third logic routine 710 can be used by the controller 330 (FIG. 3) to adjust the output of the haptic force generator 338 (FIG. 3) to achieve a uniform haptic feedback sensation felt by the user 46 (FIG. 1) when the level of noise changes. For example, the third logic routine 710 can be used by the controller 330 in step 526 of the first logic routine 510 to adjust the haptic sensation setting. The third logic routine 710 can be used independently, or in conjunction with the second logic routine 610.

At step 714, the controller 330 (FIG. 3) can determine if the noise sensed by the sensors 342 (FIG. 3) has changed amplitude. If the noise amplitude has increased, then the logic routine 710 can proceed to step 718.

At step 718, the controller 330 (FIG. 3) can change the haptic sensation setting or sensitivity such that the haptic force generator 338 (FIG. 3) will output a haptic sensation generally equal to the haptic sensation that would have been felt before the noise amplitude increased. For example, the controller 330 can increase an amplitude value of the haptic sensation setting such that the power provided to the haptic force generator 338 has a higher amplitude. Alternatively, the controller 330 can adjust the frequency or the duration of power to the haptic force generator 338 to achieve the uniform haptic sensation.

Returning to step 714, if the noise amplitude has not increased, then the logic routine 710 can proceed to step 722. At step 722, the controller 330 (FIG. 3) can determine if the noise sensed by the sensors 342 (FIG. 3) has changed amplitude. If the noise amplitude has decreased, then the logic routine 710 can proceed to step 726. It is understood that the order of steps 714 and 722 can be reversed such that the controller 330 can determine if the noise amplitude has decreased first.

At step 726, the controller 330 (FIG. 3) can change the haptic sensation setting or sensitivity such that the haptic force generator 338 (FIG. 3) will output a haptic sensation generally equal to the haptic sensation that would have been felt before the noise amplitude decreased. For example, the controller 330 can decrease the amplitude value of the haptic sensation setting such that the power provided to the haptic force generator 338 has a lower amplitude. Alternatively, the controller 330 can adjust the frequency or the duration of power to the haptic force generator 338 to achieve the uniform haptic sensation.

Returning to step 722, if the noise amplitude has not increased, then the logic routine 710 can proceed to step 730. At step 730, the logic routine 710 can end and the controller 330 (FIG. 3) can leave the haptic sensation setting unchanged.

In operation, the sensors 342 (FIG. 3) can be located proximate to the haptic force generator 338 (FIG. 3) to sense noise vibrations and the controller 330 (FIG. 3) can adjust the haptic force output of the haptic force generator 338 based on the noise vibrations, such that the user 46 (FIG. 1) senses uniform levels of haptic feedback despite changes in noise.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle system comprising:
a haptic device configured to provide haptic feedback to an occupant of a vehicle;
a sensor configured to detect vibrations felt by the occupant within the vehicle; and
a controller configured to control a level of the haptic feedback, the controller being configured to increase or decrease the level of the haptic feedback based on vibrations detected by the sensor.

2. The vehicle system of claim 1, wherein the controller is configured to increase the level of haptic feedback in response to an increase in a frequency of the vibrations detected by the sensor, and to decrease the level of haptic feedback in response to a decrease in the frequency of the vibrations detected by the sensor.

3. The vehicle system of claim 1, wherein the controller is configured to increase the level of haptic feedback in response to an increase in an amplitude of the vibrations detected by the sensor, and to decrease the level of haptic feedback in response to a decrease in the amplitude of the vibrations detected by the sensor.

4. The vehicle system of claim 1, wherein the controller is configured to increase or decrease the level of the haptic feedback based on a change in at least one of a vehicle speed, an engine operating status, or an audible noise level.

5. The vehicle system of claim 1, wherein the haptic device is one of a steering wheel, a seat, a touch pad, a touch screen, a joystick, a button, or a knob.

6. The vehicle system of claim 1, wherein the haptic device includes an electric motor and a mass, the electric motor being configured to move the mass to vibrate the haptic device.

7. The vehicle system of claim 6, wherein the mass is an eccentric rotating mass coupled for rotation with an output member of the electric motor.

8. The vehicle system of claim 1, wherein the haptic device includes a piezoelectric member.

9. The vehicle system of claim 1, wherein the haptic device includes a capacitive electro-sensory interface.

10. A method of controlling a vehicle's haptic interface, the method comprising:
detecting vibrations within the vehicle;
adjusting a sensitivity level for a haptic force of the haptic interface based on the vibrations detected;
detecting a triggering event; and
providing at the haptic interface the haptic force in response to the triggering event.

11. The method of claim 10, further comprising:
detecting an increase in a frequency of the vibrations within the vehicle; and
increasing the sensitivity level of the haptic force in response to the increase in the frequency of the vibrations within the vehicle.

12. The method of claim 10, further comprising:
detecting a decrease in a frequency of the vibrations within the vehicle; and
decreasing the sensitivity level of the haptic force in response to the decrease in the frequency of the vibrations within the vehicle.

13. The method of claim 10, further comprising:
detecting an increase in an amplitude of the vibrations within the vehicle; and
increasing a sensitivity level of the haptic force in response to the increase in the amplitude of the vibrations within the vehicle.

14. The method of claim 10, further comprising:
detecting a decrease in an amplitude of the vibrations within the vehicle; and
decreasing a sensitivity level of the haptic force in response to the decrease in the amplitude of the vibrations within the vehicle.

15. The method of claim 10, further comprising:
determining a change in one of a vehicle speed, an engine operating status, or an audible noise level;
adjusting the haptic force based on the change in the one of the vehicle speed, the engine operating status, or the audible noise level.

16. A method of controlling a vehicle's haptic interface, the method comprising:
detecting a vehicle condition including one of a vehicle speed, an engine operating status, or an audible noise level;
detecting a level of vibration within the vehicle;
adjusting a sensitivity level for an output force of the haptic interface based on the level of vibration within the vehicle and the vehicle condition;
detecting a triggering event; and
providing at the haptic interface the output force in response to the triggering event.

17. The method of claim 16, further comprising:
detecting an increase in a frequency of the level of vibration within the vehicle; and
increasing the sensitivity level of the output force in response to the increase in the frequency of the level of vibration within the vehicle.

18. The method of claim 16, further comprising:
detecting a decrease in a frequency of the level of vibration within the vehicle; and
decreasing the sensitivity level of the output force in response to the decrease in the frequency of the level of vibration within the vehicle.

19. The method of claim 16, further comprising:
detecting an increase in an amplitude of the level of vibration within the vehicle; and
increasing the sensitivity level of the output force in response to the increase in the amplitude of the level of vibration within the vehicle.

20. The method of claim 16, further comprising:
detecting a decrease in an amplitude of the level of vibration within the vehicle; and
decreasing the sensitivity level of the output force in response to the decrease in the amplitude of the level of vibration within the vehicle.
